(19) United States
(12) Patent Application Publication
(10) Pub. No.: US 2018/0091810 A1
(43) Pub. Date: Mar. 29, 2018

(54) METHOD FOR PROCESSING VIDEO SIGNAL AND DEVICE THEREFOR

(71) Applicant: LG Electronics Inc., Seoul (KR)

(72) Inventors: Eunyong SON, Seoul (KR); Seungwook PARK, Seoul (KR); Yongjoon JEON, Seoul (KR); Moonmo KOO, Seoul (KR); Jin HEO, Seoul (KR); Sunmi YOO, Seoul (KR)

(21) Appl. No.: 15/560,101

(22) PCT Filed: Mar. 22, 2016
(86) PCT No.: PCT/KR2016/002852

§ 371 Date: Sep. 20, 2017

Related U.S. Application Data
(60) Provisional application No. 62/137,176, filed on Mar. 23, 2015.

(51) Int. Cl. H04N 19/105; H04N 19/109; H04N 19/115; H04N 19/96; H04N 19/13

(52) U.S. Cl. CPC H04N 19/105; H04N 19/109; H04N 19/11; H04N 19/96; H04N 19/13; H04N 19/115

(57) ABSTRACT

The present invention relates to a method and a device for decoding a bitstream for a video signal, the method comprising the steps of: acquiring, from the bitstream, type number information and type information for a plurality of CTBs; acquiring, from the bitstream, type indication information for a current CTB among the plurality of CTBs; determining the size of the current CTB on the basis of a CTB type indicated by the type indication information; determining one or more coding blocks within the current CTB on the basis of the determined size of the current CTB and the determined minimum size of the coding block; acquiring, from the bitstream, prediction mode information with respect to each of the one or more coding blocks; and reconstructing a current coding block among the one or more coding blocks on the basis of prediction mode information related to the current coding block.

### TECHNICAL FIELD

The present invention relates to video processing, and more specifically, relates to a method and apparatus for processing a video signal using a variable/adaptive coding tree block.

### BACKGROUND ART

In accordance with the rapid development of a digital video processing technology, a digital multimedia service using various media such as high-definition digital broadcasting, digital multimedia broadcasting, internet broadcasting and the like has been activated. As the high-definition digital broadcasting becomes common, various service applications have been developed and high-speed video processing techniques for video images of high quality and high definition are required. To this end, standards for coding video signals such as H.265/HEVC (High Efficiency Video Coding) and H.264/AVC (Advanced Video Coding) have been actively discussed.

### DISCLOSURE OF THE INVENTION

### Technical Tasks

One technical task of the present invention is to provide a method of efficiently processing a video signal and an apparatus therefor.

Another technical task of the present invention is to reduce the number of bits required for sending side information and improve coding efficiency, by using a variable/adaptive coding tree block.

Still another technical task of the present invention is to provide a method of efficiently signaling side information to apply a variable/adaptive coding tree block and an apparatus therefor.

Further still another technical task of the present invention is to reduce the number of bits required for sending side information and improve coding efficiency, in case of using a coding tree block having a very large fixed size.

Technical tasks obtainable from the present invention are non-limited by the above-mentioned technical task. And, other unmentioned technical tasks can be clearly understood from the following description by those having ordinary skill in the technical field to which the present invention pertains.

### Technical Solutions

In a first aspect of the present invention, provided herein is a method of decoding a bitstream for at least one picture by a decoding apparatus, the picture including at least one slice, the slice including a plurality of coding tree blocks (CTBs), the method comprising: obtaining type number information and type information for the plurality of CTBs from the bitstream, the type number information indicating a number of CTB types allowed for the plurality of CTBs, and the type information indicating the CTB types allowed for the plurality of CTBs; obtaining type indication information for a current CTB among the plurality of CTBs from the bitstream, the type indication information indicating one CTB type of the allowed CTB types; determining a size of the current CTB and a minimum size of a coding block within the current CTB based on the CTB type indicated by the type indication information; determining at least one coding block within the current CTB based on the determined size of the current CTB and the determined minimum size of the coding block; obtaining prediction mode information for each of the at least one coding block from the bitstream, the prediction mode information indicating whether a corresponding coding block is coded using an intra prediction or an inter prediction; and reconstructing a current coding block based on prediction mode information for the current coding block among the at least one coding block.

In a second aspect of the present invention, provided herein is a decoding apparatus configured to decode a bitstream for at least one bitstream, the picture including at least one slice, the slice including a plurality of coding tree blocks (CTBs), the decoding apparatus comprising: a memory; and a processor operatively connected to the memory, wherein the processor is configured to: obtain type number information and type information for the plurality of CTBs from the bitstream, the type number information indicating a number of CTB types allowed for the plurality of CTBs, and the type information indicating the CTB types allowed for the plurality of CTBs; obtain type indication information for a current CTB among the plurality of CTBs from the bitstream, the type indication information indicating one CTB type of the allowed CTB types; determine a size of the current CTB and a minimum size of a coding block within the current CTB based on the CTB type indicated by the type indication information; determine at least one coding block within the current CTB based on the determined size of the CTB and the determined minimum size of the coding block; obtain prediction mode information for each of the at least one coding block from the bitstream, the prediction mode information indicating whether a corresponding coding block is coded using an intra prediction or an inter prediction; and reconstruct a current coding block based on prediction mode information for the current coding block among the at least one coding block.

Preferably, determining the size of the current CTB includes: constructing a CTB type candidate list for the current CTB based on the type number information and the type information, and applying a CTB type indicated by the type indication information among the CTB type candidate list to the current CTB.

Preferably, wherein the CTB type candidate list is constructed such that a CTB type of a neighboring CTB adjacent to the current CTB is assigned with a lower index.

Preferably, the neighboring CTB includes a left neighboring CTB and an upper neighboring CTB adjacent to the current CTB, and the current CTB type candidate list is constructed such that a CTB type of the left neighboring CTB corresponds to index 0 and a CTB type of the upper neighboring CTB corresponds to index 1.

Preferably, the neighboring CTB includes a left neighboring CTB and an upper neighboring CTB adjacent to the current CTB, and the CTB type candidate list is constructed such that a CTB type of the upper neighboring CTB corresponds to index 0 and a CTB type of the left neighboring CTB corresponds to index 1.

Preferably, obtaining the type number information and the type information for the plurality of CTBs from the bitstream includes obtaining a plurality of type information from the bitstream as many as times indicated by the type number information, and when the type number information indicates a number greater than 2, the CTB type candidate list is constructed such that remaining CTB types other than CTB types of the left and upper neighboring CTBs among a plurality of CTB types indicated by the plurality of type information correspond to indexes starting from 2.

Preferably, the remaining CTB types are assigned with from index 2 of the CTB type candidate list in an order of obtaining type information corresponding to the remaining CTB types from the bitstream.

Preferably, obtaining the type number information and the type information for the plurality of CTBs from the bitstream includes obtaining a plurality of type information from the bitstream as many as times indicated by the type number information, and the plurality of type information is assigned with a lower index in the CTB type candidate list according to an order of obtaining the plurality of type information from the bitstream.

Preferably, the type information comprises information about a minimum size of a coding block and information about a maximum size of the coding block, and the minimum size of the coding block in the current CTB is obtained by left shifting 1 by a value resulting from adding a specific offset to a value of the information about the minimum size of the coding block, and the size of the current CTB is obtained by left shifting 1 by a value resulting from adding the specific offset to a value of the information about the maximum size of the coding block.

Preferably, the type information comprises information about a minimum size of a coding block and information about a difference between the minimum size and a maximum size of the coding block, and the minimum size of the coding block in the current CTB is obtained by left shifting 1 by a value resulting from adding a specific offset to a value of the information about the minimum size of the coding block, and the size of the current CTB is obtained by left shifting 1 by a value resulting from adding the value resulting from adding the specific offset to the value of the information about the minimum size of the coding block to a value of the information about the difference between the minimum size and the maximum size of the coding block.

Preferably, determining the at least one coding block includes: obtaining partition indication information for the current CTB from the bitstream, when the partition indication information indicates that the current CTB is to be partitioned, partitioning the current CTB into 4 subblocks having a half horizontal size and a half vertical size of the size of the current CTB, and when a size of each subblock is greater than the minimum size of the coding block, recursively performing obtaining the partition indication information and partitioning into the 4 subblocks on each of the 4 subblocks.

Preferably, the type number information and the type information for the plurality of CTBs are obtained through a sequence parameter set (SPS), a picture parameter set (PPS), or a slice segment header (SSH).

Preferably, the plurality of CTBs have variable sizes, and each CTB corresponds to a square block.

Preferably, the CTB types allowed for the plurality of CTBs include at least one of 256×256 block, 128×128 block, 64×64 block, 32×32 block, 16×16 block, or 8×8 block.

Preferably, when the prediction mode information for the current coding block indicates that the current coding block is coded using intra prediction, reconstructing the current coding block includes, deriving an intra prediction mode for the current coding block, determining at least one transform block from the current coding block, and obtaining a prediction value by applying the intra prediction mode to the transform block, and reconstructing the transform block based on the prediction value.

Preferably, when the prediction mode information for the current coding block indicates that the current coding block is coded using inter prediction, reconstructing the current coding block includes, obtaining partitioning mode information for the current coding block from the bitstream, determining at least one prediction block from the current coding block based on the partitioning mode information, deriving inter prediction parameter information for the prediction block, obtaining a prediction value for the prediction block based on the inter prediction parameter information, and reconstructing the prediction block based on the prediction value.

### Advantageous Effects

According to the present invention, a video signal can be efficiently processed.

Further, according to the present invention, the number of bits required for sending side information can be reduced and coding efficiency can be improved, by using a variable/adaptive coding tree block.

Further, according to the present invention, side information can be efficiently signaled to apply a variable/adaptive coding tree block.

Further, according to the present invention, the number of bits required for sending side information can be saved and coding efficiency can be improved, in case of using a coding tree block having a very large fixed size.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention, illustrate embodiments of the invention and together with the description serve to explain the principle of the invention.

FIG. 1 illustrates an encoding procedure.

FIG. 2 illustrates a decoding procedure.

FIG. 3 illustrates a flow chart for a method of partitioning a coding tree block (CTB).

FIG. 4 illustrates an example of partitioning a CTB by a quadtree scheme.

FIG. 5 illustrates an example of syntax information and operations for a coding block.

FIG. 6 illustrates an example of syntax information and operations for a transform tree.

FIG. 7 illustrates one example of partitioning one picture into coding blocks according to texture characteristics.

FIG. 8 exemplarily illustrates CTB according to the conventional method and CTB according to the present invention.

FIG. 9 illustrates an example of a CTB scan order according to the present invention.

FIG. 10 illustrates one example of a flowchart of a method according to the present invention.

FIG. 11 illustrates CTB and coding block according to the present invention.

FIG. 12 illustrates a block diagram of a video processing apparatus to which the present invention can be applied.

### BEST MODE FOR INVENTION

A technology described in the following can be used for an image signal processing apparatus configured to encode and/or decode a video signal. Generally, a video signal corresponds to an image signal or a sequence of pictures capable of being recognized by eyes. Yet, in the present specification, the video signal can be used for indicating a sequence of bits representing a coded picture or a bit stream corresponding to a bit sequence. A picture may indicate an array of samples and can be referred to as a frame, an image, or the like. More specifically, the picture may indicate a two-dimensional array of samples or a two-dimensional sample array. A sample may indicate a minimum unit for constructing a picture and may be referred to as a pixel, a picture element, a pel, or the like. The sample may include a luminance (luma) component and/or a chrominance (chroma, color difference) component. In the present specification, coding may be used to indicate encoding or may commonly indicate encoding/decoding.

A picture may include at least one or more slices and a slice may include at least one or more blocks. The slice can be configured to include the integer number of blocks for purposes such as parallel processing, resynchronization of decoding when a bit stream is damaged due to data loss, and the like. Each slice can be independently coded. A block may include at least one or more samples and may indicate an array of samples. A block may have a size equal to or a less than a size of a picture. A block may be referred to as a unit. A currently coded picture may be referred to as a current picture and a block currently being coded may be referred to as a current block. There may exist various block units constructing a picture. For example, in case of ITU-T H.265 standard (or High Efficiency Video Coding (HEVC) standard), there may exist such a block unit as a coding tree block (CTB) (or a coding tree unit (CTU)), a coding block (CB) (or a coding unit (CU)), a prediction block (PB) (or a prediction unit (PU)), a transform block (TB) (or a transform unit (TU)), and the like.

The coding tree block corresponds to the most basic unit for constructing a picture and can be divided into coding blocks of a quad-tree form to improve coding efficiency according to texture of a picture. The coding block may correspond to a basic unit for performing coding and intra-coding or inter-coding can be performed in a unit of the coding block. The intra-coding is to perform coding using intra prediction and the intra prediction is to perform prediction using samples included in the same picture or slice. The inter-coding is to perform coding using inter prediction and the inter prediction is to perform prediction using samples included in a picture different from a current picture. A block coded using the intra-coding or coded in an intra prediction mode may be referred to as an intra block, and a block coded using the inter-coding or coded in an inter prediction mode may be referred to as an inter block. And, a coding mode using intra prediction can be referred to as an intra mode, and a coding mode using inter prediction can be referred to as an inter mode.

The prediction block may correspond to a basic unit for performing prediction. Identical prediction can be applied to a prediction block. For example, in case of the inter prediction, the same motion vector can be applied to one prediction block. The transform block may correspond to a basic unit for performing transformation. The transformation may correspond to an operation of transforming samples of a pixel domain (or a spatial domain or a time domain) into a conversion coefficient of a frequency domain (or a transform coefficient domain), or vice versa. In particular, an operation of converting a conversion coefficient of the frequency domain (or transform coefficient domain) into samples of the pixel domain (or spatial domain or time domain) can be referred to as inverse transformation. For example, the transformation may include discrete cosine transform (DCT), discrete sine transform (DST), a Fourier transform, and the like.

In the present specification, a coding tree block (CTB) may be interchangeably used with a coding tree unit (CTU), a coding block (CB) may be interchangeably used with a coding unit (CU), a prediction block (PB) may be interchangeably used with a prediction unit (PU), and a transform block (TB) may be interchangeably used with a transform unit (TU).

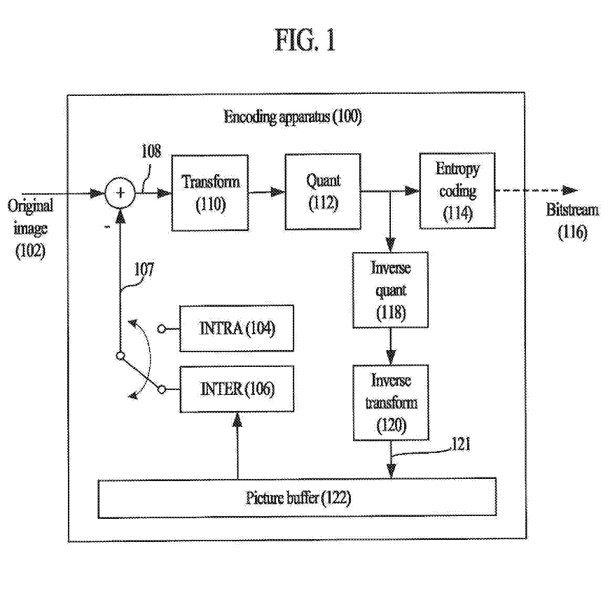

FIG. 1 illustrates an encoding procedure.

An encoding apparatus 100 receives an input of an original image 102, performs encoding on the original image, and outputs a bit stream 114. The original image 102 may correspond to a picture. Yet, in the present example, assume that the original image 102 corresponds to a block for constructing a picture. For example, the original image 102 may correspond to a coding block. The encoding apparatus 100 can determine whether the original image 102 is coded in intra mode or inter mode. If the original image 102 is included in an intra picture or a slice, the original image 102 can be coded in the intra mode only. However, if the original image 102 is included in an inter picture or a slice, for example, it is able to determine an efficient coding method in consideration of RD (rate-distortion) cost after the intra-coding and the inter-coding are performed on the original image 102.

In case of performing the intra-coding on the original image 102, the encoding apparatus 100 can determine an intra-prediction mode showing RD optimization using reconstructed samples of a current picture including the original image 102 (104). For example, the intra-prediction mode can be determined by one selected from the group consisting of a direct current (DC) prediction mode, a planar prediction mode and an angular prediction mode. The DC prediction mode corresponds to a mode in which prediction is performed using an average value of reference samples among reconstructed samples of a current picture, the planar prediction mode corresponds to a mode in which prediction is performed using bilinear interpolation of reference samples, and the angle prediction mode corresponds to a mode in which prediction is performed using a reference sample located in a specific direction with respect to the original image 102. The encoding apparatus 100 can output a predicted sample or a prediction value (or predictor) 107 using the determined intra prediction mode.

When the inter-coding is performed on the original image 102, the encoding apparatus 100 performs motion estimation (ME) using a reconstructed picture included in a (decoded) picture buffer 122 and may be then able to obtain motion information (106). For example, the motion information can include a motion vector, a reference picture index, and the like. The motion vector may correspond to a two-dimensional vector that provides an offset from a coordinate of the original image 102 to a coordinate in a reference picture in a current picture. The reference picture index may correspond to an index for a list of reference pictures (or a reference picture list) used for inter prediction among the reconstructed pictures stored in the (decoded) picture buffer 122. The reference picture index indicates a corresponding reference picture. The encoding apparatus 100 can output a predicted sample or a predicted value 107 using the obtained motion information.

Subsequently, the encoding apparatus 100 can generate a residual data 108 from a difference between the original image 102 and the predicted sample 107. The encoding apparatus 100 can perform a transformation on the generated residual data 108 (110). For example, Discrete Cosine Transform (DCT), Discrete Sine Transform (DST), and/or wavelet transform can be applied for the transformation. More specifically, it may use an integer-based DCT having a size of 4×4 to 32×32 and 4×4, 8×8, 16×16, and 32×32 transforms can be used. The encoding apparatus 100 performs transformation 110 to obtain transform coefficient information.

The encoding apparatus 100 quantizes the transform coefficient information to generate quantized transform coefficient information (112). Quantization may correspond to an operation of scaling a level of the transform coefficient information using a quantization parameter (QP). Hence, the quantized transform coefficient information may be referred to as scaled transform coefficient information. The quantized transform coefficient information can be output as a bit stream 116 via entropy coding 114. For example, the entropy coding 114 can be performed based on fixed length coding (FLC), variable length coding (VLC), or arithmetic coding. More specifically, it may apply context adaptive binary arithmetic coding (CABAC) based on arithmetic coding, Exp-Golomb coding based on variable length coding, and fixed length coding.

And, the encoding apparatus 100 performs inverse quantization 118 and inverse transformation 120 on the quantized transform coefficient information to generate a reconstructed sample 121. Although it is not depicted in FIG. 1, in-loop filtering can be performed on a reconstructed picture after obtaining the reconstructed picture by acquiring the reconstructed sample 121 for a picture. For the in-loop filtering, for example, it may apply a deblocking filter, a sample adaptive offset (SAO) filter. Subsequently, the reconstructed picture 121 is stored in the picture buffer 122 and can be used for encoding a next picture.

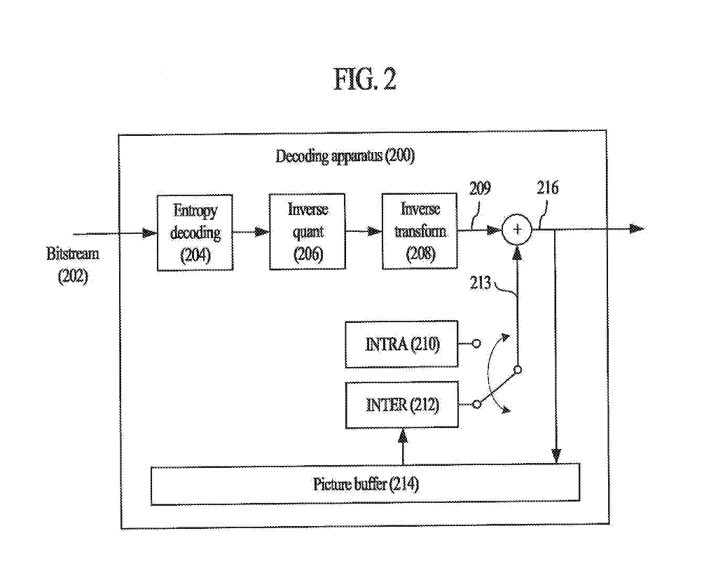

FIG. 2 illustrates a decoding procedure.

A decoding apparatus 200 receives a bit stream 202 and can perform entropy decoding 204. The entropy decoding 204 may correspond to a reverse operation of the entropy coding 114 mentioned earlier in FIG. 1. The decoding apparatus 200 can obtain data and (quantized) transform coefficient information necessary for decoding by including prediction mode information, intra prediction mode information, motion information, and the like through the entropy decoding 204. The decoding apparatus 200 can generate a residual data 209 by performing inverse quantization 206 and inverse transformation 208 on the obtained transform coefficient information.

The prediction mode information obtained through the entropy decoding 204 can indicate whether a current block is coded in intra mode or inter mode. If the prediction mode information indicates the intra mode, the decoding apparatus 200 can obtain a prediction sample (or prediction value) 213 from reconstructed samples of a current picture based on the intra prediction mode obtained through the entropy decoding 204 (210). If the prediction mode information indicates the inter mode, the decoding apparatus 200 can obtain a prediction sample (or prediction value) 213 from a reference picture stored in the picture buffer 214 based on the motion information obtained through the entropy decoding 204 (212).

The decoding apparatus 200 can obtain a reconstructed sample 216 for the current block using the residual data 209 and the prediction sample (or prediction value). Although it is not depicted in FIG. 2, in-loop filtering can be performed on a reconstructed picture after the picture is reconstructed by obtaining the reconstructed sample 216 for a picture. Subsequently, the reconstructed picture 216 can be stored in the picture buffer to decode a next picture or can be outputted for display.

A video encoding/decoding process requires very high complexity for software/hardware (SW/HW) processing. Hence, in order to perform a job of high complexity using a limited resource, it is able to process a picture (or video) in a manner of partitioning it by a basic processing unit that is a minimum processing unit. Thus, one slice may include at least one basic processing unit. In this case, a basic processing unit included in one picture or slice may have a same size.

In case of HEVC (High Efficiency Video Coding) standard (ISO/IEC 23008-2 or ITU-T H.265), as described above, a basic processing unit may be referred to as CTB (Coding Tree Block) or CTU (Coding Tree Unit) and have a size of 64×64 pixels. Hence, in case of the HEVC standard, a single picture can be encoded/decoded in a manner of being divided by CTU that is a basic processing unit. For detailed example, in case of encoding/decoding 8192×4096 picture, it is able to perform an encoding procedure shown in FIG. 1 or a decoding procedure shown in FIG. 2 on 8,192 CTUs resulting from dividing a picture into the 8,192 CTUs (=128×64).

A video signal or bitstream may include a sequence parameter set (SPS), a picture parameter set (PPS), at least one access unit. The sequence parameter set includes parameter information (of pictures) in a sequence level, and the parameter information of the sequence parameter set may be applied to pictures included in a sequence of pictures. The picture parameter set includes parameter information in a picture level, and information of the picture parameter set may be applied to each slice included in a picture. The access unit refers to a unit corresponding to one picture, and may include at least one slice. A slice may include an integer number of CTUs. Syntax information refers to data included in a bitstream, and a syntax structure refers to a structure of syntax information which is present in a bistream in a specific order.

A size of a coding tree block may be determined using parameter information of SPS. The SPS may include first information indicating the minimum size of a coding block and second information indicating a difference between the minimum size of the coding block and the maximum size of the coding block. In the present specification, the first information may be referred to as log 2_min_luma_coding_block_size_minus3, and the second information may be referred to as log 2_diff_max_min_luma_coding_block_size. Generally, the size of a block may be represented by a power of 2, and thus each information may be represented as a log 2 value of an actual value. Thus, a log 2 value of the minimum size of the coding block may be obtained by adding a specific offset (e.g. 3) to a value of the first information, and a log 2 value of the size of a coding tree block may be obtained by adding a value of the second information to a log 2 value of the minimum size of the coding block. The size of the coding tree block may be obtained by left shifting 1 by the log 2 value. The second information indicating a difference between the minimum size and the maximum size may represent a maximum number of times for partitioning for coding blocks within a coding tree block. Or, the second information may represent a maximum depth of a coding tree within a coding tree block.

Specifically, assuming that a value of the first information (e.g. log 2_min_luma_coding_block_size_minus3) among parameter information of SPS is n, and a value of the second information (e.g. log 2_diff_max_min_luma_coding_block_size) is m, the minimum size N×N of the coding block may be determined to be N=1<<(n+3), and the size M×M of the coding tree block may be determined to be M=1<<(n+m+3) or N<<m. Further, the maximum number of allowed partitioning times for the coding block or the maximum depth of the coding tree within the coding tree block may be determined to be m.

For example, assuming that the size of the coding tree block is 64×64 and the maximum depth of the coding tree within the coding tree block is 3, the coding tree block may be partitioned up to 3 times using a coding tree scheme, and the minimum size of the coding block may be 8×8. Thus, the first information (e.g. log 2_min_luma_coding_block_size_minus3) among parameter information of SPS may have a value of 0, and the second information (e.g. log 2_diff_max_min_luma_coding_block_size) may have a value 3.

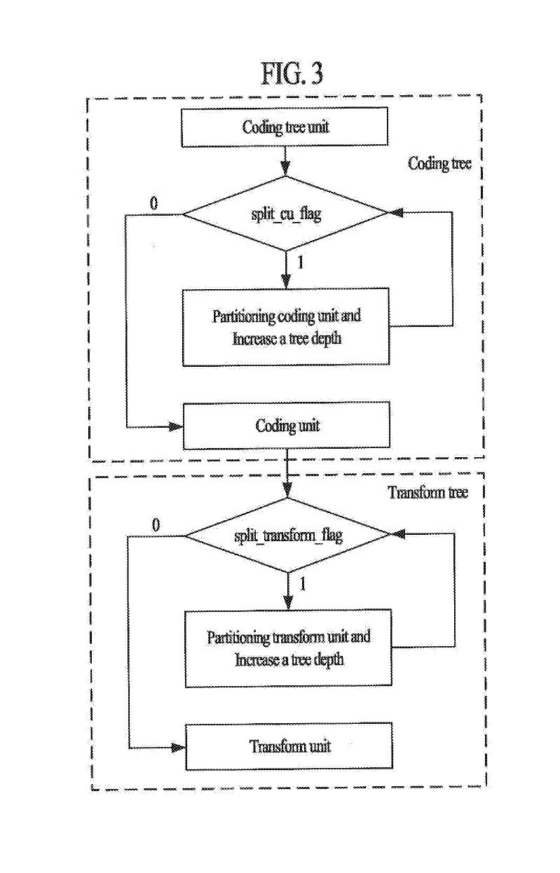

FIG. 3 illustrates a flow chart for a method of partitioning a coding tree block (CTB).

In the HEVC standard, unlike the existing video coding standards (e.g., VC-1, AVC), for the compression efficiency enhancement, after partitioning CTB into at least one coding block (CB) by a quadtree scheme, an intra or inter prediction mode can be determined for a coding block. If CTB is not partitioned, the CTB may correspond to a CB. In this case, the CB may have the same size of the CTB, and an intra or inter prediction mode can be determined for the corresponding CTB.

When a CTB is partitioned by a quadtree scheme, it may be partitioned recursively. After a CTB has been partitioned into 4 blocks, each of the blocks may be partitioned again into subblocks by a quadtree scheme in addition. Each block finally generated by recursively partitioning a CTB by a quadtree scheme may become a coding block. For example, after a CTB has been partitioned into first to fourth blocks, if the first block is partitioned into fifth to eighth blocks but the second to fourth blocks are not partitioned, the second to eighth blocks can be determined as coding blocks. In this example, an intra or inter prediction mode may be determined for each of the second to eighth blocks.

Whether a CTB is partitioned into a coding block may be determined by an encoder side in consideration of RD (rate distortion) efficiency, and information indicating a presence or non-presence of partition may be included in a bitstream. For example, information indicating whether a CTB or a coding block is partitioned into a coding block having a half horizontal/vertical size may be referred to as split_cu_flag in HEVC standard. Information indicating whether a block is partitioned within a CTB may be called a partition indication information for a coding block. A decoder side determines whether to partition a coding block by obtaining information indicating a presence or non-presence of partition for each coding block within a coding quadtree from a bitstream and is able to partition the coding block recursively by a quadtree scheme. A coding tree or coding quad tree refers to a tree structure of coding blocks formed by recursively partitioning a CTB. If each coding block is not partitioned anymore within a coding tree, the corresponding block may be finally referred to as a coding block.

As described above, a coding block can be partitioned into at least one prediction block to perform a prediction. Moreover, a coding block can be partitioned into at least one transform block to perform a transformation. In a manner similar to that of a CTB, a coding block may be recursively partitioned into a transform block by a quadtree scheme. A structure formed by partitioning a coding block by a quadtree scheme may be called a transform tree or a transform quad tree, and information indicating whether each block is partitioned within a transform tree may be included in a bitstream, which is similar to the partition indication information. For example, information indicating whether a block is partitioned into a unit having a half horizontal/vertical size for a transformation in HEVC standard may be called split_transform_flag. Information indicating whether each block is partitioned in a transform tree may be called partition indication information for a transform block.

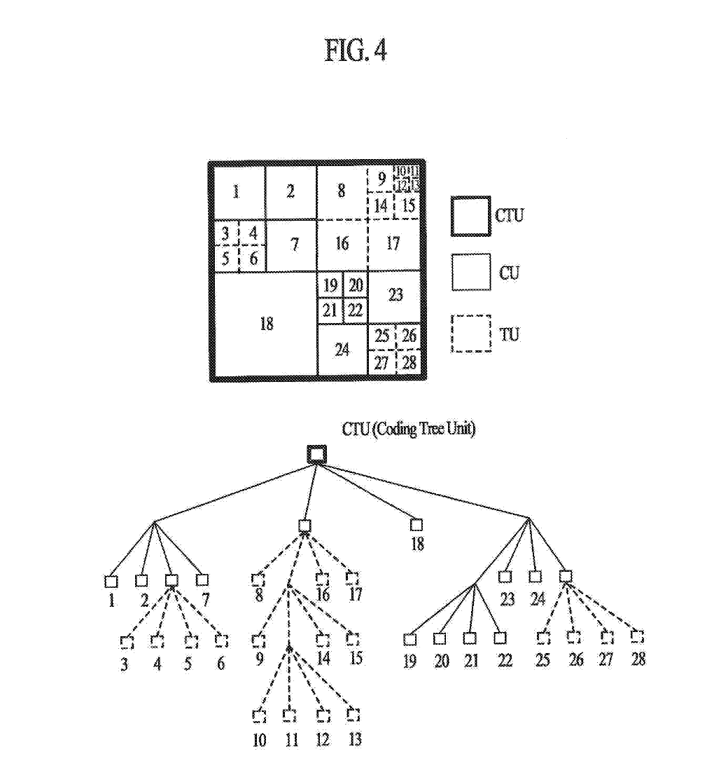

FIG. 4 illustrates an example of partitioning a CTB by a quadtree scheme.

Referring to FIG. 4, a CTB may be partitioned into a first coding block containing blocks 1 to 7, a second coding block containing blocks 8 to 17, a third coding block corresponding to a block 18, and a fourth coding block containing blocks 19 to 28. The first coding block may be partitioned into a coding block corresponding to the block 1, a coding block corresponding to the block 2, a fifth coding block containing the blocks 3 to 6, and a coding block corresponding to the block 7. The second coding block may be partitioned into additional transform blocks for transformation despite failing to be further partitioned within a coding quadtree. The fourth coding block may be partitioned into a sixth coding block containing the blocks 19 to 22, a coding block corresponding to the block 23, a coding block corresponding to the block 24, and a seventh coding block containing the blocks 25 to 28. The sixth coding block may be partitioned into a coding block corresponding to the block 19, a coding block corresponding to the block 20, a coding block corresponding to the block 21, and a coding block corresponding to the block 22. And, the seventh coding block may be partitioned into additional transform blocks for transformation despite failing to be further partitioned within a coding quadtree.

As described above, information (e.g., split_cu_flag) indicating a presence or non-presence of partition for a CTB or each coding block may be included in a bitstream. If the information indicating a presence or non-presence of partition has a first value (e.g., 1), the CTB or each coding block can be partitioned. If the information indicating a presence or non-presence of partition has a second value (e.g., 0), the CTB or each coding block is not partitioned. And, a value of the information indicating a presence or non-presence of partition may vary.

In the example shown in FIG. 4, the partition indication information (e.g., split_cu_flag) for the CTB, the first coding block, the fourth coding block and the sixth coding block may have the first value (e.g., 1). A decoder obtains partition indication information on the corresponding block from the bitstream and is then able to partition the corresponding unit into 4 subunits. On the other hand, the partition indication information (e.g., split_cu_flag) for other coding blocks (coding blocks corresponding to block 1, block 2, block 7, blocks 18 to 23, and blocks 3 to 6, coding blocks corresponding to blocks 8 to 17, and coding blocks corresponding to blocks 25 to 28) may have the second value (e.g., 0). The decoder obtains the partition indication information on the corresponding unit from the bitstream and does not further partition the corresponding unit according to this value.

As described above, each coding block may be partitioned into at least one transform block by a quadtree scheme according to partition indication information for a transform block for transformation. Referring now to FIG. 4, since a coding block corresponding to the blocks 1, 2, 7 and 18 to 24 is not partitioned for transformation, a transform block may correspond to a coding block but another coding block (a coding block corresponding to the blocks 3 and 4, 8 to 17, or 25 to 28) may be additionally partitioned for transformation. Partition indication information (e.g., split_transform_flag) for each unit within a transform tree formed from each coding block (e.g., a coding block corresponding to the blocks 3, 4, 8 to 17, or 25 to 28) and the corresponding coding block can be partitioned into a transform block according to a value of the partition indication information. As shown in FIG. 4 exemplarily, a coding block corresponding to the blocks 3 to 6 may be partitioned into transform blocks to form a transform tree of depth 1, a coding block corresponding to the blocks 8 to 17 may be partitioned into transform blocks to form a transform tree having depth 3, and a coding block corresponding to the blocks 25 to 28 may be partitioned into transform blocks to form a transform tree having depth 1.

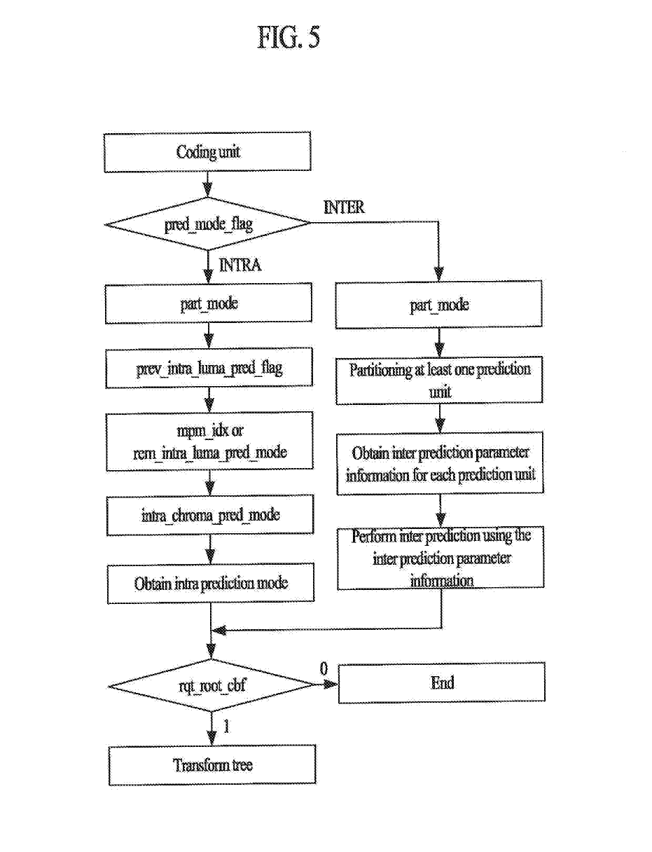

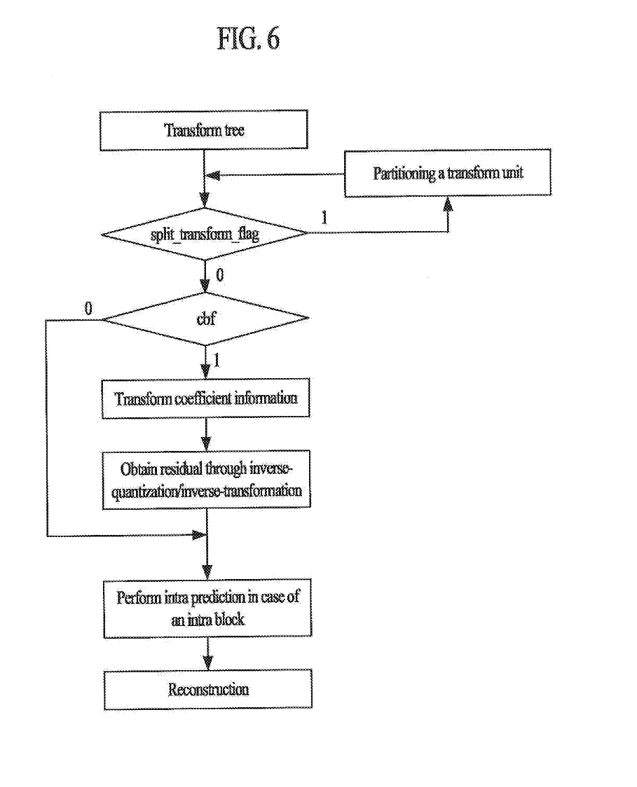

FIG. 5 shows one example of syntax information and operations for a coding block, and FIG. 6 shows one example of syntax information and operations for a transform tree. As exemplarily shown in FIG. 5, information indicating whether a transform tree structure of a current coding block exists can be signaled through a bitstream. In the present specification, such information may be called transform tree coding indication information or rgt_root_cbf. A decoder obtains the transform tree coding indication information from the bitstream. If the transform tree coding indication information indicates that a transform tree for a corresponding coding block exists, the decoder can perform the operation shown in FIG. 6. If the transform tree coding indication information indicates that the transform tree for the corresponding coding block does not exist, transform coefficient information for the corresponding coding block does not exist and the coding block can be reconstructed using a prediction value (intra or inter prediction value) for the corresponding coding block.

A coding block is a basic unit for determining whether it is coded in intra or inter prediction mode. Hence, prediction mode information for each coding block can be signaled through a bitstream. The prediction mode information may indicate whether the corresponding coding block is coded using an intra prediction mode or an inter prediction mode.

If the prediction mode information indicates that the corresponding coding block is coded in the intra prediction mode, informations used in determining the intra prediction mode can be signaled through the bitstream. For example, the information used in determining the intra prediction mode may include intra prediction mode reference information. The intra prediction mode reference information indicates whether an intra prediction mode of a current coding block is derived from a neighbor (prediction) unit, and may be referred to as prev_intra_luma_pred_flag for example.

If the intra prediction mode reference information indicates whether the intra prediction mode of the current coding block is derived from the neighbor (prediction) unit, an intra prediction mode candidate list is constructed using an intra prediction mode of the neighbor unit and index information indicating an intra prediction mode of the current unit in the configured candidate list can be signaled through the bitstream. For example, index information indicating a candidate intra prediction ode used as the intra prediction mode of the current unit in the intra prediction mode candidate list may be referred to as mpm_idx. The decoder obtains the intra prediction mode reference information from the bitstream and may obtain the index information from the bitstream based on the obtained intra prediction mode reference information. Moreover, the decoder may set the intra prediction mode candidate indicated by the obtained index information as the intra prediction mode of the current unit.

If the intra prediction mode reference information does not indicate that the intra prediction mode of the current coding block is not derived from the neighbor unit, information indicating the intra prediction mode of the current unit can be signaled through the bitstream. The information signaled through the bitstream may be referred to as rem_intra_luma_pred_mode for example. The information obtained from the bitstream is compared with values of candidates in the intra prediction mode candidate list. If the obtained information is equal to or greater than the values, the intra prediction mode of the current unit can be obtained by an operation of increment by a specific value (e.g., 1).

If a picture contains a chroma component (or color difference component), information indicating an intra prediction mode for a chroma coding block may be signaled through a bitstream. For example, information indicating a chroma intra prediction mode can be referred to as intra_chroma_pred_mode. The chroma intra prediction mode can be obtained based on Table 1 using the information indicating the chroma intra prediction mode and the intra prediction mode obtained as described above (or the luma intra prediction mod). In Table 1, IntraPredModeY indicates the luma intra prediction mode.

TABLE 1

| | IntraPredModeY | | | | |
|---|---|---|---|---|---|
| intra_chroma_pred_mode | 0 | 26 | 10 | 1 | X (0 <= X <= 34) |
| 0 | 34 | 0 | 0 | 0 | 0 |
| 1 | 26 | 34 | 26 | 26 | 26 |
| 2 | 10 | 10 | 34 | 10 | 10 |
| 3 | 1 | 1 | 1 | 34 | 1 |
| 4 | 0 | 26 | 10 | 1 | X |

An intra prediction mode indicates various prediction odes according to values. A value of an intra prediction mode may correspond to an intra prediction mode, as shown in Table 2, through the aforementioned process.

TABLE 2

| Intra prediction mode | Associated name |
|---|---|
| 0 | INTRA_PLANAR |
| 1 | INTRA_DC |
| 2 . . . 34 | INTRA_ANGULAR2_INTRA_ANGULAR34 |

In Table 2, INTRA_PLANAR indicates a planar prediction mode and also indicates a mode for obtaining a prediction value of a current block by performing an interpolation on a reconstructed sample of an upper neighbor block adjacent to a current block, a reconstructed sample of a left neighbor block, a reconstructed sample of a lower-left neighbor block, and a reconstructed sample of a right-upper neighbor block. INTRA_DC indicates a DC (Direct Current) prediction mode, and also indicates a mode for obtaining a prediction value of a current block using averages of the reconstructed samples of left neighbor block and the reconstructed samples of upper neighbor block. INTRA_ANGULAR2 to INTRA_ANGULAR34 indicate angular prediction mode, and also indicate a mode for finding a prediction value of a current sample using a reconstructed sample of a neighbor block located in a direction of a specific angle for a current sample within a current block. If a real sample fails to exist in the direction of the specific angle, it is able to find a prediction value in a manner of generating a virtual sample for the corresponding direction by performing an interpolation on neighbor reconstructed samples.

An intra prediction mode may be found per coding block. Yet, intra prediction may be performed by a unit of a transform block. Hence, the aforementioned reconstructed sample of the neighbor block may refer to a reconstructed sample existing within a neighbor block of a current transform block. After finding a prediction value for a current block using an intra prediction mode, it is able to find a difference between the sample value of the current block and the prediction value. The difference between the sample value of the current block and the prediction value may be referred to as a residual (or residual information or residual data). A decoder side obtains transform coefficient information on the current block from a bitstream and is then able to find a residual by performing dequantization and inverse transform on the obtained transform coefficient information. Dequantization may refer to scaling a value of transform coefficient information using a quantization parameter (QP). Since a transform block is a basic unit for performing a transform, transform coefficient information can be signaled through a bitstream by a unit of the transform block.

In case of performing an intra prediction, a residual may be 0. For example, if a sample of a current block is identical to a reference sample for intra prediction, a value of a residual may be 0. If a residual value for a current block is 0 all, since a value of transform coefficient information is 0 all, it is not necessary to signal the transform coefficient information through a bitstream. Hence, information indicating whether transform coefficient information for a corresponding block is signaled through a bitstream can be signaled through a bitstream. Information indicating whether a corresponding transform block has transform coefficient information that is not 0 refers to coded block indication information or coded block flag information, and may be referred to as cbf in the present specification. Coded block indication information for a luma component may be referred to as cbf_luma and coded block indication information for a chroma component may be referred to as cbf_cr or cbf_cb. The decoder obtains coded block indication information for a corresponding transform block from a bitstream. If the coded block indication information indicates that the corresponding block contains transform coefficient information that is not 0, the decoder obtains the transform coefficient information for the corresponding transform block from the bitstream and is also able to obtain a residual through dequantization and inverse transform.

If a current coding block is coded in intra prediction mode, the decoder finds a prediction value for the current coding block by finding a prediction value by transform block unit and/or may find a residual for the current coding block by finding a residual by transform block unit. The decoder can reconstruct the current coding block using the prediction value and/or residual for the current coding block.

As a transform/inverse transform scheme, a discrete cosine transform (DCT) is used popularly. Transform bases for DCT may be approximated in integer form for small memory and fast operation. Transform bases approximated into integers can be represented as a matrix form. And, the transform bases represented in matrix form may be referred to as a transform matrix. In the H.265/HEVC standard, integer transforms in 4×4 to 32×32 sizes are used and a 4×4 or 32×32 transform matrix is provided. The 4×4 transform matrix may be used for 4×4 transform/inverse transform, and the 32×32 transform matrix may be used for 8×8, 16×16, or 32×32 transform/inverse transform.

Meanwhile, if prediction mode information for a current coding block indicates that a current coding block is coded using inter prediction, information indicating a partitioning mode of the current coded coding can be signaled through a bitstream. The information indicating the partitioning mode of the current coding block may be represented as part_mode for example. If the current coding block is coded using inter prediction, the current coding block can be partitioned into at least one prediction block according to the partitioning mode of the current coding block.

For example, assuming that a current coding block is 2N×2N block, partitioning modes may include PART_2N×2N, PART_2N×N, PART_N×2N, PART_2N×nU, PART_2N×nD, PART_nL×2N, PART_nR×2N, and PART_N×N. PART_2N×2N indicates a mode that a current coding block is equal to a prediction block. PART_2N×N indicates a mode that a current coding block is partitioned into 2 2N×N prediction blocks. PART_N×2N indicates that a current coding block is partitioned into 2N×2N prediction blocks. PART_2N×nU indicates a mode that a current coding block is partitioned into an upper 2N×n prediction block and a lower 2N×(N−n) prediction block. PART_2N×nD indicates a mode that a current coding block is partitioned into an upper 2N×(N−n) prediction block and a lower 2N×n prediction block. PART_nL×2N indicates a mode that a current coding block is partitioned into a left n×2N prediction block and a right (N−n)×2N prediction block. PART_nR×2N indicates a mode that a current coding block is partitioned into a left (N−n)×2N prediction block and a right n×2N prediction block. PART_N×N indicates a mode that a current coding block is partitioned into 4N×N prediction blocks. For example, n is N/2.

Even if a current coding block is in intra coding mode, part_mode can be signaled through a bitstream. Yet, when a current coding block is in intra coding mode, only if a size of the current coding block is a minimum size of a coding block, part_mode is signaled. And, it is able to indicate whether the current coding block is additionally partitioned into 4 blocks.

A prediction unit is a unit for performing motion estimation and motion compensation. Hence, inter prediction parameter information can be signaled through a bitstream by a unit of a prediction unit. The inter prediction parameter information may include reference picture information, motion vector information and the like for example. The inter prediction parameter information may be derived from a neighbor unit or signaled through a bitstream. A case of deriving the inter prediction parameter information from the neighbor unit is referred to as a merge mode. Hence, information indicating whether inter prediction parameter information for a current prediction unit is derived from a neighbor unit can be signaled through a bitstream. And, the corresponding information may refer to merge indication information or merge flag information. The merge indication information may be represented as merge_flag.

If a merge indication mode indicates that inter prediction parameter information of a current prediction unit is derived from a neighbor unit, a merge candidate list is constructed using the neighbor unit, information indicating a merge candidate to derive the inter prediction parameter information of the current unit in the merge candidate list can be signaled through a bitstream, and the corresponding information may be referred to as merge index information. For example, the merge index information may be represented as merge_idx. Neighbor blocks may include spatial neighbor blocks including a left neighbor block adjacent to a current block, an upper neighbor block, an upper-left neighbor block, a lower-left neighbor block, and an upper-right neighbor block in a picture including the current block and a temporal neighbor block located (or co-located) at a position corresponding to the current block in a picture different from the picture including the current block. The decoder may construct a merge candidate list using the neighbor blocks, obtain merge index information from the bitstream, and set inter prediction parameter information of a neighbor block indicated by the merge index information in the merge candidate list as inter prediction parameter information of the current block.

Meanwhile, when a prediction block corresponds to a coding block, as a result of performing inter prediction on the prediction block, if inter prediction information is identical to a specific neighbor block and residual is 0 all, it is not necessary to signal the inter prediction parameter information, transform coefficient information and the like through a bitstream. In this case, since the inter prediction parameter information for a coding block can be just derived from a neighbor block, a merge mode is applicable. Hence, in case that a corresponding coding block is coded using inter prediction, only merge index information can be signaled through a bitstream for the corresponding coding block. Such a mode is referred to as a merge skip mode. Namely, in the merge skip mode, syntax information for a coded lock is not signaled except merge index information (e.g., merge_idx). Yet, in order to indicate that it is unnecessary to further obtain syntax information except the merge index information (e.g., merge_idx) for the corresponding coding block, skip flag information may be signaled through a bitstream. In the present specification, the skip flag information may be referred to as cu_skip_flag. The decoder obtains skip flag information for the coding block from a slice not in intra coding mode and is able to reconstruct the coding block in the merge skip mode according to the skip flag information.

If a merge indication mode does not indicate that inter prediction parameter information of a current prediction block is derived from a neighbor block, an inter prediction parameter of a current prediction block may be signaled through a bitstream. Reference index information for a reference picture list 0 and/or reference index information for a reference picture list 1 can be signaled through a bitstream depending on whether it is L0 and/or L1 prediction of the current prediction block. Regarding motion vector information, information indicating a motion vector difference and information indicating a motion vector prediction value (predictor) can be signaled through a bitstream. The information indicating the motion vector predictor is index information indicating a candidate used as a motion vector prediction value of a current block in a motion vector predictor candidate list constructed with motion vectors of neighbor blocks, and may be referred to as motion vector predictor indication information. The motion vector predictor indication information may be represented as mvp_l0_flag or mvp_l1_flag for example. The decoder obtains a motion vector predictor based on motion vector predictor indication information, finds a motion vector difference by obtaining information related to a motion vector difference from a bitstream, and is able to find motion vector information for a current block using the motion vector predictor and the motion vector difference.

If a current coding block is coded using inter prediction, the identical/similar principle may apply to a transform block except that inter prediction is performed by a prediction block unit. Hence, in case of coding a current coding block using inter prediction, the current coding block is partitioned into at least one transform block by a quadtree scheme, transform coefficient information is obtained based on coded block indication information (e.g., cbf_luma, cbf_cb, cbf_cr) for each partitioned transform block, and a residual can be obtained by performing dequantization and inverse transform on the obtained transform coefficient information.

In case that a current coding block is coded in intra prediction mode, the decoder finds a prediction value for the current coding block by finding a prediction value by prediction block unit and/or is able to find a residual for the current coding block by finding a residual by transform block unit. The decoder can reconstruct the current coding block using the prediction value and/or residual for the current coding block.

The HEVC standard supports ultra high resolution (e.g., 4096×2160) video over 4K. In the ultra high resolution video over 4K, a homogeneous region may increase. Particularly, in case of a video having resolution over 8K (e.g., 8192×4320), a size of a homogeneous region may further increase in comparison with 4K video. Moreover, if resolution is raised despite that a scene inputted to a camera is intact, a block size of a region covered by CTU in existing resolution increases but a CTU size remains intact. Hence, it may bring an effect that a size (64×64) of an existing CTU decreases relatively. Hence, if a CTUS size greater than a CTU size (e.g., 64×64) supported by the existing HEVC standard is used, coding efficiency can be further raised.

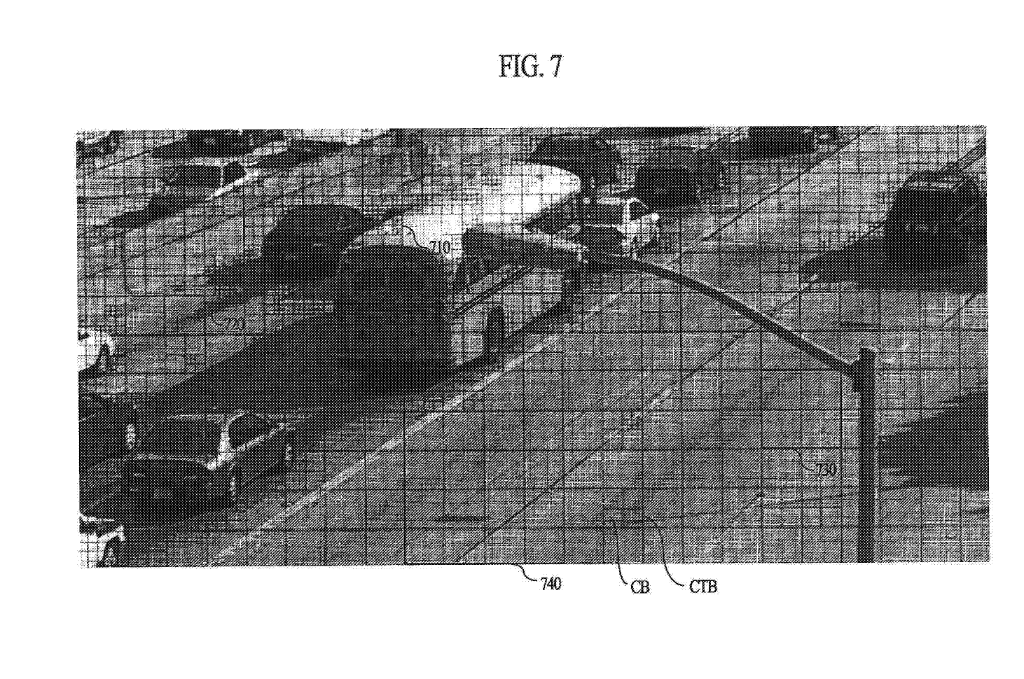

FIG. 7 shows one example of partitioning a single picture into coding blocks according to texture characteristics.

Referring to FIG. 7, a single picture can be partitioned into a coding tree block in fixed size (e.g., 64×64). And, each coding tree block is partitioned into at least one coding block, thereby forming a coding tree. In the example of FIG. 7, although a CTB size is equal, a coding block in the CTB may have various sizes according to a tree depth or a partition count.

As shown in FIG. 7, texture having various properties may exist in a single picture. For instance, in case of a complicated texture part like a CTB 710, it may be efficient to perform encoding/decoding by partitioning it into small coding blocks. On the contrary, regarding a region having similar properties owing to simple texture like a CTB 720, it may be efficient to perform encoding/decoding without partitioning a CTB into a plurality of coding blocks.

Particularly, in case that a region corresponding to 4 CTBs have similar characteristics like a region 730, it may be more efficient to perform encoding/decoding without partitioning the whole corresponding region into 4 CTBs. In case that a single picture is partitioned into CTB in fixed size, it is necessary to signal syntax information for each of 4 CTBs through a bitstream. For example, partition indication information (e.g., split_cu_flag) indicating whether CTB is partitioned by a quadtree scheme for each of 4 CTBs can be signaled through a bitstream (e.g., refer to FIG. 3). Hence, although each CTB in the corresponding region 730 is encoded/decoded by CTB unit without being partitioned into a plurality of coding blocks (e.g., a case that a value of split_cu_flag for each CTB is 0), partition indication information for each CTB should be signaled. For example, since the region 730 corresponds to 4 CTBs and each CTB corresponds to a coding block without being partitioned, split_cu_flag is signaled for each CTB and 4-bit partition indication information can be signaled for the region 730.

On the other hand, if the region 730 is assigned to a single CTB and the corresponding CTB is not partitioned into a plurality of coding blocks, partition indication information may be signaled once only for the whole corresponding region 730. Hence, it is able to reduce at least 3 bits in comparison with an existing method. If a region in lager size is processed as a single CTB owing to the similar characteristics of the region, it is able to reduce a bigger number of bits. For example, a region 740 corresponds to 16 CTBs. If the region 740 is processed as a single CTB, it is able to reduce at least 15 bits in comparison with an existing method.

If image resolution is raised, a region having similar texture characteristics may increase. Hence, if coding is performed by binding into one large block, coding efficiency can be improved. In case of using CTB in fixed size according to an existing method, since coding should be performed in a manner of partitioning a region having similar texture characteristics (e.g., smooth region) into several CTBs, a situation that unnecessary side information (e.g., split_cu_flag) should be sent may happen.

To solve such a problem, it is able to consider raising a size of CTB (e.g., 128×128 or 256×256). Namely, it is able to consider a scheme of partitioning a single picture into CTB in bigger fixed size (e.g., 128×128 or 256×256) and then processing it by CTB unit of the bigger fixed size. Yet, in this case, coding efficiency may be raised in a simple region having similar texture characteristics. Yet, in case of a fine texture region, a partition count by the quadtree scheme may further increase in comparison with an existing method. For example, in a situation that a picture is processed by being partitioned by CTB unit of 256×256 size, as texture of a specific region is complicated, assume that it is necessary to partition it into 8×8 coding blocks. In this case, according to an existing method, 64×64 CTB needs to be partitioned three times by a quadtree scheme. Yet, 256×256 CTB needs to be partitioned five times by a quadtree scheme. Hence, if a size of CTB is simply raised, a transmission quantity of side information (e.g., split_cu_flag) may increase instead and coding efficiency may be lowered.

Method 1 According to the Present Invention

To solve the above-mentioned technical problem, the present invention proposes to determine a CTB size adaptively according to texture characteristics. Particularly, the present invention proposes a method of variably changing a CTB size in a single slice or picture. CTB of the present invention has a variable size within a single picture or slice and may correspond to a square block having a variable size for example.

In case of variably changing a CTB size in a single slice or picture, CTB in large size may be used for a region having similar texture characteristics (e.g., smooth region) or CTB in small size may be used for a region having complicated texture characteristics. Therefore, according to the present invention, since it is able to reduce an amount of syntax information or side information signaled for CTB, coding efficiency can be improved.

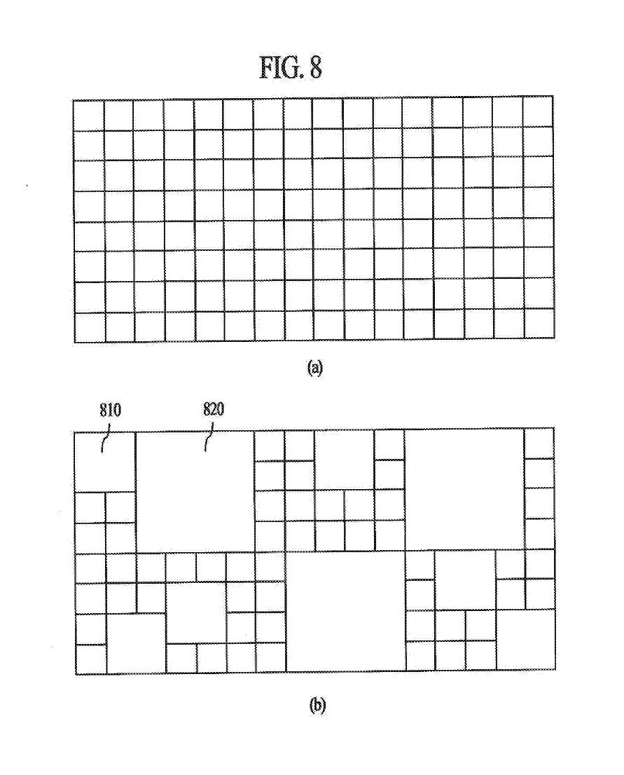

FIG. 8 exemplarily shows CTB according to the conventional method and CTB according to the present invention. FIG. 8 (a) shows an example of processing a single picture by partitioning it into CTB in fixed size. FIG. 8 (b) shows an example of adaptively determining a size of CTB in a single picture or slice and processing the single picture or slice by partitioning it into CTN in adaptive size.

As illustrated in FIG. 8, in case of determining a size of CTB according to texture characteristics variably/adaptively, a larger region can be processed as a single CTB. For example, although a CTB 810 can be processed as 4 CTBs according to an existing method, it can be processed as a single CTB according to the present invention. Hence, in case of the CTB 810, at least 3-bit side or syntax information can be saved and coding efficiency can be improved. For another example, although a CTB 820 may be processed as 16 CTBs according to the existing method, it can be processed as a single CTB according to the present invention. Hence, in case of the CTB 820, at least 16-bit side or syntax information can be saved and coding efficiency can be improved.

CTB Type Signaling According to the Present Invention

According to the present invention, in order to apply variable/adaptive CTB, signal information about a CTB type applicable to a current picture or slice and/or information about the number of CTB types can be signaled through a bitstream. In the present specification, a CTB type may refer to a size of CTB and/or a maximum depth of a coding tree within CTB. Or, the CTB type may refer to a CTB size and/or a minimum size of a coding block within CTB. Or, the CTB type may refer to a CTB size and/or a maximum partition count of CTV. For example, an applicable CTB size in the present invention may include at least one of 256×256 block, 128×128 block, 64×64 block, 32×32 block, 16×16 block, and 8×8 block.

In the present specification, information about a CTB type may be referred to as CTB type information, type information, and ctb_type_n (n=0, 1 . . . ). For example, CTB type information may include information indicating a minimum size of a coding block and/or information indicating a maximum size of a coding block. In this case, since the maximum size of the coding block is equal to that of CTB, a size of the CTB may be determined using the maximum size of the coding block, and a maximum depth of a coding tree within CTB may correspond to a difference between the maximum size of the coding block and the minimum size of the coding block.

For another example, CTB type information may include information indicating a minimum size of a coding block and/or information indicating a difference between minimum and maximum sized of the coding block. In this case, a size of CTB may be determined by adding the minimum size of the coding block and the difference together, and a maximum depth of a coding tree within CTB may correspond to the difference.

A value of information indicating a minimum size of a coding block and a value of information indicating a maximum size of the coding block may be represented as a log 2 value. For example, if a minimum size of a coding block is N×N, information indicating the minimum size of the coding block can have a value of log 2(N). If a maximum size of a coding block is M×M, information indicating the maximum size of the coding block can have a value of log 2(M). Or, a value of information indicating a minimum size of a coding block and a value of information indicating a maximum size of the coding block can be represented as a value resulting from subtracting a specific offset from the log 2 value. For example, if a specific offset is P and a minimum size of a coding block is N×N, information indicating the minimum size of the coding block can have a value of ‘log 2(N)−P’. If a maximum size of a coding block is M×M, information indicating the maximum size of the coding block can have a value of ‘log 2(M)−P’.

In the present specification, information about the CTB type number may be referred to as type number information, CTB type number information, or ctb_type_num. CTB type information may be signaled through a bitstream as many as a count indicated by the CTB type number information. A bitstream of the present invention may include CTB type information as many as a count indicated by CTB type number information. For example, if CTB type number information indicates that the CTB type number is n, n CTB type informations can be signaled through a bitstream.

Or, a single information indicating a minimum size of a coding block is signaled only, and information indicating a maximum size of the coding block or information indicating a difference between minimum and maximum sizes of the coding block can be signaled as many times as a count indicated by CTB type number information.

Or, after a CTB type has been defined in advance, CTB type information can indicate one of predefined CTB types. In this case, CTB type information may indicate an index indicating one of the predefined CTB types. For example, if n1×n1, n2×n2 . . . nm×nm CTB types are defined in advance, an index indicating a corresponding type can be signaled through a bitstream. In this case, for non-limited example, n1×n1 may correspond to an index 0, n2×n2 may correspond to an index 1, and nm×nm may correspond to an index m−1.

According to the present invention, CTB type information and CTB type number information may be signaled through a sequence parameter set (SPS), a picture parameter set (PPS), or a slice (segment) header (SSH). If signaled through SPS, the corresponding CTB type information and the corresponding CTB type number information are applicable to all pictures included in a corresponding sequence and may indicate CTB types a CTB can have in each picture and the number of types.

If signaled through PPS, the corresponding information is applicable to a corresponding picture only and a default value is applicable to another picture. Default values for CTB type information and CTB type number information may be predefined. Hence, CTB type information and CTB type number information signaled through PPS may indicate CTB types a CTB can have in a corresponding picture and the number of types.

In case that CTB type information and CTB type number information are signaled through SSH, they are applicable to CTB included in a corresponding slice only and a default value is applicable to another slice. CTB type information and CTB type number information signaled through SSH may indicate CTB types a CTB can have in a corresponding slice and the number of types.

CTB type information and/or CTB type number information may be signaled through at least two of SPS, PPS and SSH. In this case, if signaled through SSH, the corresponding information is applicable within a corresponding slice only and information signaled from an upper level (SPS or PPS) is applicable to another slice. Similarly, if signaled through PPS, the information is applicable within a corresponding picture only and information signaled from an upper level (SPS) is applicable to another picture.

Meanwhile, information indicating a CTB type can be signaled for each CTB through a bitstream. Information of CTB may include information indicating one of supportable CTB types signaled through SPS, PPS and SSH. In the present specification, CTB type information signaled for CTB may be referred to as type indication information, CTB type indication information, or ctb_type_idx. In this case, a supportable CTB type candidate list is configured using the CTB type information and the CTB type number information signaled through SPS, PPS and SSH. And, a CYB type indicated by the CTB type indication information in the configured list can be applied to the corresponding CTB.

For example, CTB types of n1×n1, n2×n2 nm×nm are signaled through SPS, PPS and slice (segment) header, a list is configured in a manner that n1×n1, n2×n2 and nm×nm correspond to an index 0, an index 1 and an index m−1, respectively, and a CTB type of an index corresponding to CTB type indication information in the list can be applied to the corresponding CTB. For detailed example, if CTB types of 256×256, 128×128, 64×64, and 32×32 are signaled, a list of {256×256, 128×128, 64×64, 32×32} is configured. If CTB type indication information indicates the index 0, the corresponding CTB type is determined as 256×256. If CTB type indication information indicates the index 1, the corresponding CTB type is determined as 128×128. If CTB type indication information indicates the index 2, the corresponding CTB type is determined as 64×64. If CTB type indication information indicates the index 3, the corresponding CTB type is determined as 32×32.

An index in a CTB type candidate list may be designated randomly. Or, the index may be designated in order of each CTB type information in SPS, PPS and SSH. In this case, an encoder may configure a bitstream in a manner that a frequently used CTB type corresponds to a low index value. Since a low index value can be represented as small bits, there is an effect of saving the number of bits. In case of a decoder, CTB type number information is obtained from a bitstream for SPS, PPS and SSH, CTB type information is obtained from the bitstream as many times as a count indicated by the CTB type number information, and a CTB type candidate list can be then configured so as to assign a low index value in order of obtaining the CTB type information. For example, if the decoder obtains CTB type information in order of 64×64, 32×32, 128×128, and 256×256, the decoder configures a CTB type candidate list with {64×64, 32×32, 128×128, 256×256} and is able to apply a type indicated by the CTB type indication information for each CTB (or, a type corresponding to an indicated index) to the corresponding CTB.

Or, it is able to configure a CTB type candidate list in a manner that a different index is provided for each CTB. Since it is highly probable that a current CTB has a type similar to that of a neighboring CTB adjacent to the current CTB, a CTB type candidate list can be configured so that the neighboring CTB adjacent to the current CTB among candidate CTB types is assigned to a low index. Neighboring CTBs adjacent to the current CTB may include a left neighboring CTB and an upper neighboring CTB adjacent to the current CTB. In this case, for example, a CTB type of the left neighboring CTB is assigned to an index 0 and a CTB type of the upper neighboring CTB is assigned to an index 1. If two or more CTB types supportable for a current slice exist, they can be assigned to indexes by starting with an index 2. A CTB type assigned to an index by starting with the index 2 can be assigned to have a lower index value when a size gets smaller. Or, a CTB type assigned to an index by starting with the index 2 can be assigned to have a lower index value when a size gets bigger. Or, a CTB type assigned to an index by starting with the index 2 can be assigned to have a lower index value in order of being signaled through SPS, PPS or SSH. Therefore, a CTB type candidate list may vary per CTB, which can be considered in determining CTB type indication information.

CTB Processing Order According to the Present Invention

If a size or type of CTB is adaptively/variably determined according to the present invention, a CTP processing order or a CTB scanning scheme may follow the raster-scan order. Particularly, in case of applying adaptive/variable CTB, it is able to apply the raster-scan order with reference to a location of an upper-left corner sample of CTB.

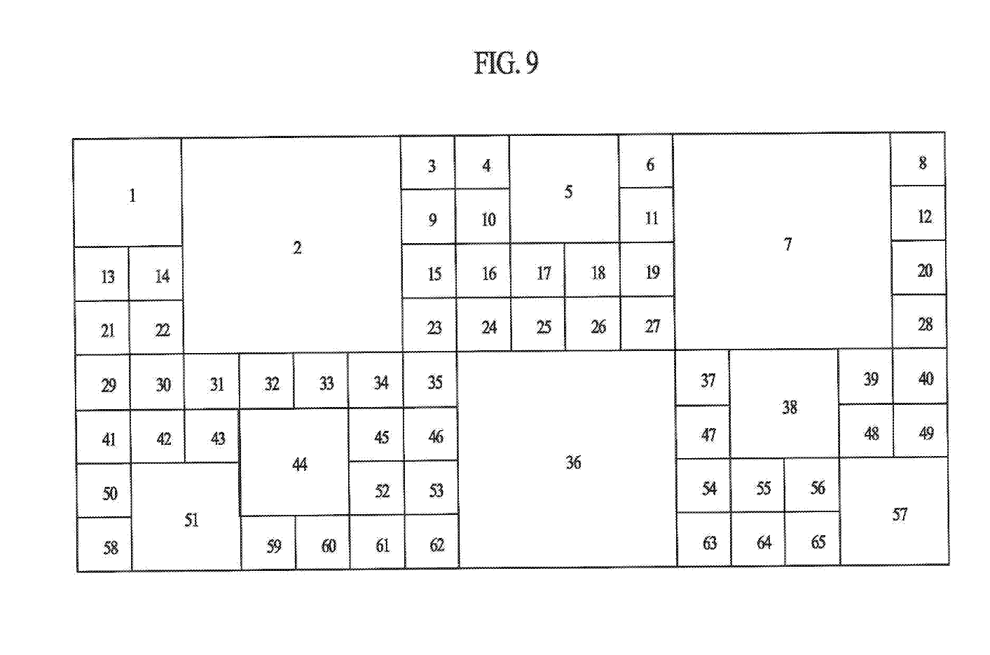

FIG. 9 shows an example of a CTB scan order according to the present invention. In the example of FIG. 9, each rectangle indicates a CTB and the numerals indicate a scan order. Moreover, in the example of FIG. 9, a single picture is assumed as having 65 CTBs in variable size, by which the present invention is non-limited.

Referring to FIG. 9, if the raster scan order is applied with reference to a location of an upper-left corner sample of CTB, CTB 2 can be processed behind CTB 1. Likewise, CTB 3 can be processed behind CTB 2. After CTB 8 has been processed, CTB 9 corresponds to a next raster scan order with reference to an upper-left corner, CTB 9 is processed. Thus, 65 CTBs can be processed in sequence.

Meanwhile, in the example of FIG. 9, assuming that CTB 3, CTB 1 and CTB 2 correspond to 64×64 type, 128×128 type and 256×256 type, respectively, an example of a method of configuring a CTB type candidate list is described with reference to FIG. 9.

In the example of FIG. 9, since there are 3 supportable types in a single picture, CTB type number information signaled through SPS, PPS or SSH may indicate 3. Hence, 3 CTB type informations can be sequentially signaled through SPS, PPS or SSH. If a minimum size of a coding block is determined independently per CTB, CTB type information may include 3 informations indicating the minimum size of the coding block and 3 informations indicating a maximum size of the coding block (or 3 informations indicating a difference between the minimum and maximum sizes of the coding block). If the minimum size of the coding block is fixed, the CTB type information may include 1 information indicating the minimum size of the coding block and 3 informations indicating a difference between the minimum and maximum sizes of the coding block (or 3 informations indicating the maximum side of the coding block).

Based on this, in case of configuring a CTB type candidate list according to a size of a supportable CTB, the CTB type candidate list may be configured with {256×256, 128×128, 64×64} or {64×64, 128×128, 256×256}. Or, in case of configuring a CTB type candidate list in order of being signaled through SPS, PPS or SSH, the CTB type candidate list can be configured to correspond to the CTB type information obtained order.

Or, in case of configuring a CTB type candidate list per CTB independently, the CTB type candidate list can be configured in a manner of configuring left and upper neighboring CTBs adjacent to a current CTB to correspond to low indexes and adding the rest of CTB types behind. In the example of FIG. 9, in case of CTB 14, a CTB type candidate list can be configured with {64×64, 128×128, 256×256}. In case of CTB 31, a CTB type candidate list can be configured with {64×64, 256×256, 128×128}. In case that the left and upper neighboring CTBs have the same CTB type, the same CTB type is assigned to an index 0 and indexes are designated to the rest of indexes according to CTB size or the CTB type information obtained order.

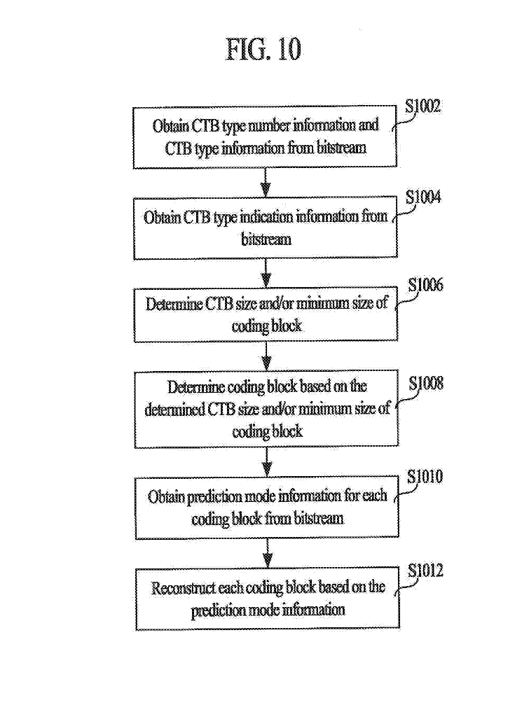

FIG. 10 shows one example of a flowchart of a method according to the present invention. The method shown in FIG. 10 may be performed on a bitstream containing at least one picture (or coded picture). A single picture may include at least one slice. And, each slice may include a series of CTBs. CTBs in a single picture or slice may have variable sizes. CTB in a single picture or slice may have a square block shape. Hence, encoding/decoding can be performed in a manner of partitioning a single picture into CTBs in variable sizes.

Referring to FIG. 10, in a step S1002, a decoder may obtain CTB type number information and CTB type information from a bitstream. The description related to the CTB type signaling according to the present invention is applicable to CTB type number information and CTB type information.

As described above, CTB number information and CTB type information can be signaled through SPS, PPS and SSH. Hence, the decoder obtains SPS from the bitstream, and the obtained SPS may include CTB number information and CTB type information. Or, the decoder obtains PPS from the bitstream, and the obtained PPS may include CTB number information and CTB type information. Or, the decoder obtains SSH from the bitstream, and the obtained SSH may include CTB number information and CTB type information.

In a step S1004, the decoder may obtain CTB type indication information from the bitstream. The description related to the CTB type signaling according to the present invention is applicable to CTB type indication information.

In a step S106, the decoder can configure a CTB type candidate list based on the CTB number information and the CTB type information. The CTB type candidate list can be configured in various ways described above. The decoder may apply a CTB type indicated by the CTB type indication information in the CTB type candidate list to a current CTB. For example, the decoder can determine a size of a CTB type indicated by the CTB type indication information in the CTB type candidate list as a size of the current CTB. Moreover, a coding block minimum size (or, coding tree maximum depth or CTB maximum partition count) of the CTB type indicated by the CTB type indication information can be determined as a coding block minimum size (or, coding tree maximum depth or CTB maximum partition count) of the current CTB.

In a step S1008, the decoder may determine at least one coding block from the CTB based on the determined CTB type. For example, the quadtree scheme described with reference to FIG. 3 and FIG. 4 is applicable to the CTB. Based on partition indication information (e.g., split_cu_flag) on the CTB, the CTB may correspond to a single coding block or may be recursively partitioned into a plurality of blocks by the quadtree scheme. In case that the CTB is partitioned recursively, it can be partitioned until a partitioned block corresponds to a minimum coding block size in the CTB.

In a step S1010, the decoder may obtain prediction mode information for each coding block, which is formed from the CTB, from the bitstream. For example, the prediction mode information may correspond to pred_mode_flag of FIG. 3.

In a step S1012, the decoder may reconstruct each coding block based on the obtained prediction mode information. For example, the decoder can reconstruct the CTB by reconstructing each coding block by performing the procedure described with reference to FIG. 5 and FIG. 6.

In case that all CTBs for at least one picture are reconstructed, decoding for the corresponding picture can be completed.

Method 2 According to the Present Invention

In case of determining a CTB type variably/adaptively using the method 1 according to the present invention, a processing size and/or a coding tree structure may vary per CTB, whereby inefficiency of a hardware structure (e.g., a pipeline structure) may occur. For example, if some CTB has a 256×256 size, a hardware structure for processing the 256×256 size is necessary. Yet, since a different CTB may have a size much smaller than the former size, when a CTB in small size is processed, most of the corresponding hardware structure may not be used.

To complement such inefficiency, a method 2 according to the present invention proposes to fix a size of CTB to a size (e.g., 128×128, 256×256) greater than that of an existing method. Particularly, in the method 2 according to the present invention, minimum and maximum sizes of a coding block are determined per CTB and then the CTB can be uniformly partitioned in maximum size of the coding block. In this case, a coding tree may be formed per block corresponding to the maximum size of the coding block, and the procedures shown in FIG. 3, FIG. 5 and FIG. 6 can be performed per block corresponding to the maximum size of the coding block partitioned in the CTB.

To this end, a fixed size of CTB may be predefined or signaled through SPS, PPS or SSH. For example, if a fixed size of CTB is signaled through SPS, PPS or SSH, as described above, the fixed size of the CTB can be determined using log 2_min_luma_coding_block_size_minus3 and log 2_diff_max_min_luma_coding_block_size. Moreover, information indicating a minimum size of a coding block and information indicating a maximum size of the coding block may be signaled per CTB through a bitstream. Or, information indicating a minimum size of a coding block and information indicating a difference between minimum and maximum sizes of the coding block may be signaled per CTB through a bitstream.

The decoder obtains information indicating the minimum size of the coding block and the information indicating the maximum size of the coding block (or, the information indicating a difference between minimum and maximum sizes of the coding block) from the bitstream per CTB and is able to determine the minimum size and the maximum size of the coding block. Thereafter, the decoder equally partitions the CTB in fixed size into blocks having the maximum size of the coding block. The decoder can form a coding tree for each of the partitioned blocks. For example, the decoder can perform the procedures described with reference to FIGS. 3 to 6 on each of the partitioned blocks.

In case of the method 2 according to the present invention, as CTB in fixed size is uniformly partitioned into blocks corresponding to a maximum size of a coding block, side information (e.g., split_cu_flag) is not used for the uniform partitioning of the CTB. Moreover, if a coding block in CTB is partitioned up to a minimum size, side information (e.g., split_cu_flag) indicating a presence or non-presence of partitioning is not used for the coding block in the minimum size. Therefore, the number of bits corresponding to the side information can be saved and the coding efficiency can be improved.

As a modification of the method 2 according to the present invention, a minimum size of a coding block is signaled through SPS, PPS, or SSH and a difference between minimum and maximum sizes of the coding block can be signaled per CTB. In this case, the minimum size of the coding block is applicable to CTBs in a corresponding sequence, picture or slice in common.

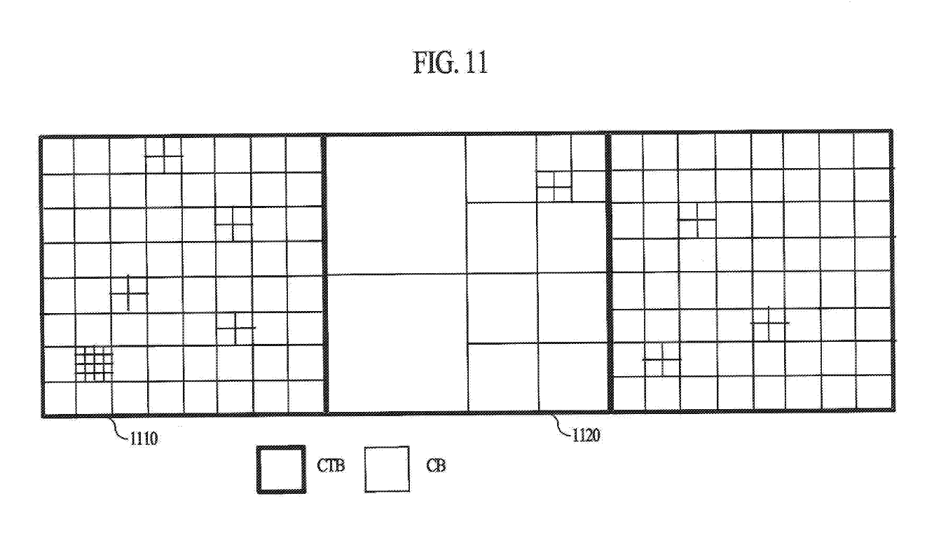

FIG. 11 shows CTBs and coding blocks according to the present invention. The method 2 according to the present invention may apply to the example of FIG. 11. And, assume that CTB has a fixed size of 256×256. Yet, as described above, the fixed size of the CTB can be signaled through SPS, PPS, or SSH.

Referring to FIG. 11, for example, a maximum size of a coding block for CTB 1110 may be set to 32×32 and a minimum size of the coding block may be set to 8×8. In this case, the CTB 1110 is equally partitioned into 32×32 blocks corresponding to the maximum size of the coding block without side information (e.g., split_cu_flag), whereby encoding/decoding (e.g., procedures according to FIGS. 3 to 6) can be performed. Yet, since the minimums size of the coding block is set to 8×8, partitioning may be performed up to 8×8 coding block only, a quadtree for each 32×32 block may have depth up to the depth 2, and partitioning of the quadtree scheme is applicable up to two times only. Since it is not necessary to signal separate side information (e.g., split_cu_flag) until CTB in 256×256 size is partitioned into 32×32 block, at least 85 bits of side information can be saved. Moreover, it is not necessary to signal separate side information (e.g., split_cu_flag) for 8×8 coding block.

For another example, a maximum size of a coding block for CTB 1120 may be set to 128×128 and a minimum size of the coding block may be set to 16×16. In this case, the CTB 1120 is equally partitioned into 128×128 blocks corresponding to the maximum size of the coding block without side information (e.g., split_cu_flag), whereby encoding/decoding (e.g., procedures according to FIGS. 3 to 6) can be performed. Yet, since the minimums size of the coding block is set to 16×16, partitioning may be performed up to 16×16 coding block only, a quadtree for each 128×128 block may have depth up to the depth 3, and partitioning of the quadtree scheme is applicable up to three times only. Since it is not necessary to signal separate side information (e.g., split_cu_flag) until CTB in 256×256 size is partitioned into 128×128 block, at least 1 bit of side information can be saved.

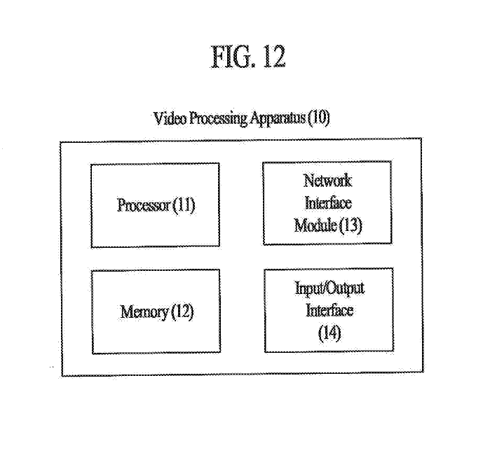

FIG. 12 illustrates a block diagram to which the present invention can be applied. The video processing apparatus may include an encoding apparatus and/or a decoding apparatus of a video signal. For example, the video processing apparatus to which the present invention can be applied may include a mobile terminal such as a smart phone, a mobile equipment such as a laptop computer, a consumer electronics such as a digital TV, a digital video player, and etc.

A memory 12 may store program for processing and controlling by a processor 11, and may store a coded bitstream, a reconstructed image, control information, and the like. Further, the memory 12 may be used as a buffer for various video signals. The memory 12 may be implemented as a storage device such as a ROM (Read Only Memory), RAM (Random Access Memory), EPROM (Erasable Programmable Read Only Memory), EEPROM (Electrically Erasable Programmable Read-Only Memory), a flash memory, SRAM (Static RAM), HDD (Hard Disk Drive), SSD (Solid State Drive), and etc.

The processor 11 controls operations of each module in the video processing apparatus. The processor 11 may perform various control functions to perform encoding/decoding according to the present invention. The processor 11 may be referred to as a controller, a microcontroller, a microprocessor, a microcomputer, or etc. The processor 11 may be implemented as a hardware or a firmware, a software, or a combination thereof. When the present invention is implemented using a hardware, the processor 11 may comprise ASIC (application specific integrated circuit), DSP (digital signal processor), DSPD (digital signal processing device), PLD (programmable logic device), FPGA (field programmable gate array), or the like. Meanwhile, when the present invention is implemented using a firmware or a software, the firmware or software may comprise modules, procedures, or functions that perform functions or operations according to the present invention. The firmware or software configured to perform the present invention may be implemented in the processor 11 or may be stored in the memory 12 and executed by the processor 11.

In addition, the apparatus 10 may optionally include a network interface module (NIM) 13. The network interface module 13 may be operatively connected with the processor 11, and the processor 11 may control the network interface module 13 to transmit or receive wireless/wired signals carrying information, data, a signal, and/or a message through a wireless/wired network. For example, the network interface module 13 may support various communication standards such as IEEE 802 series, 3GPP LTE(-A), Wi-Fi, ATSC (Advanced Television System Committee), DVB (Digital Video Broadcasting), and etc, and may transmit and receive a video signal such as a coded bitstream and/or control information according to the corresponding communication standard. The network interface module 13 may not be included as necessary.

In addition, the apparatus 10 may optionally include an input/output interface 14. The input/output interface 14 may be operatively connected with the processor 11, and the processor 11 may control the input/output interface 14 to input or output a control signal and/or a data signal. For example, the input/output interface 14 may support specifications such as USB (Universal Serial Bus), Bluetooth, NFC (Near Field Communication), serial/parallel interface, DVI (Digital Visual Interface), HDMI (High Definition Multimedia Interface) so as to be connected with input devices such as a keyboard, a mouse, a touchpad, a camera and output devices such as a display.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

The embodiments of the present invention may be implemented by various means, for example, hardware, firmware, software, or a combination thereof. In a hardware implementation, an embodiment of the present invention may be implemented by one or more application specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software implementation, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be applied to a video processing apparatus such as a decoding apparatus or an encoding apparatus.

What is claimed is:

1. A method of decoding a bitstream for at least one picture by a decoding apparatus, the picture including at least one slice, the slice including a plurality of coding tree blocks (CTBs), the method comprising:
obtaining type number information and type information for the plurality of CTBs from the bitstream, the type number information indicating a number of CTB types allowed for the plurality of CTBs, and the type information indicating the CTB types allowed for the plurality of CTBs;
obtaining type indication information for a current CTB among the plurality of CTBs from the bitstream, the type indication information indicating one CTB type of the allowed CTB types;
determining a size of the current CTB and a minimum size of a coding block within the current CTB based on the CTB type indicated by the type indication information;
determining at least one coding block within the current CTB based on the determined size of the current CTB and the determined minimum size of the coding block;
obtaining prediction mode information for each of the at least one coding block from the bitstream, the prediction mode information indicating whether a corresponding coding block is coded using an intra prediction or an inter prediction; and
reconstructing a current coding block based on prediction mode information for the current coding block among the at least one coding block.

2. The method of claim 1, wherein determining the size of the current CTB includes:
constructing a CTB type candidate list for the current CTB based on the type number information and the type information, and
applying a CTB type indicated by the type indication information among the CTB type candidate list to the current CTB.

3. The method of claim 2, wherein the CTB type candidate list is constructed such that a CTB type of a neighboring CTB adjacent to the current CTB is assigned with a lower index.

4. The method of claim 3, wherein the neighboring CTB includes a left neighboring CTB and an upper neighboring CTB adjacent to the current CTB, and wherein the current CTB type candidate list is constructed such that a CTB type of the left neighboring CTB corresponds to index 0 and a CTB type of the upper neighboring CTB corresponds to index 1.

5. The method of claim 3, wherein the neighboring CTB includes a left neighboring CTB and an upper neighboring CTB adjacent to the current CTB, and wherein the CTB type candidate list is constructed such that a CTB type of the upper neighboring CTB corresponds to index 0 and a CTB type of the left neighboring CTB corresponds to index 1.

6. The method of claim 3, wherein obtaining the type number information and the type information for the plurality of CTBs from the bitstream includes obtaining a plurality of type information from the bitstream as many as times indicated by the type number information, and
wherein when the type number information indicates a number greater than 2, the CTB type candidate list is constructed such that remaining CTB types other than CTB types of the left and upper neighboring CTBs among a plurality of CTB types indicated by the plurality of type information correspond to indexes starting from 2.

7. The method of claim 6, wherein the remaining CTB types are assigned with from index 2 of the CTB type candidate list in an order of obtaining type information corresponding to the remaining CTB types from the bitstream.

8. The method of claim 2, wherein obtaining the type number information and the type information for the plurality of CTBs from the bitstream includes obtaining a plurality of type information from the bitstream as many as times indicated by the type number information, and
wherein the plurality of type information is assigned with a lower index in the CTB type candidate list according to an order of obtaining the plurality of type information from the bitstream.

9. The method of claim 1, wherein the type information comprises information about a minimum size of a coding block and information about a maximum size of the coding block, and
wherein the minimum size of the coding block in the current CTB is obtained by left shifting 1 by a value resulting from adding a specific offset to a value of the information about the minimum size of the coding block, and the size of the current CTB is obtained by left shifting 1 by a value resulting from adding the specific offset to a value of the information about the maximum size of the coding block.

10. The method of claim 1, wherein the type information comprises information about a minimum size of a coding block and information about a difference between the minimum size and a maximum size of the coding block, and
wherein the minimum size of the coding block in the current CTB is obtained by left shifting 1 by a value resulting from adding a specific offset to a value of the information about the minimum size of the coding block, and the size of the current CTB is obtained by left shifting 1 by a value resulting from adding the value resulting from adding the specific offset to the value of the information about the minimum size of the coding block to a value of the information about the difference between the minimum size and the maximum size of the coding block.

11. The method of claim 1, wherein determining the at least one coding block includes:
obtaining partition indication information for the current CTB from the bitstream,
when the partition indication information indicates that the current CTB is to be partitioned, partitioning the current CTB into 4 subblocks having a half horizontal size and a half vertical size of the size of the current CTB, and
when a size of each subblock is greater than the minimum size of the coding block, recursively performing obtaining the partition indication information and partitioning into the 4 subblocks on each of the 4 subblocks.

12. The method of claim 1, wherein the type number information and the type information for the plurality of CTBs are obtained through a sequence parameter set (SPS), a picture parameter set (PPS), or a slice segment header (SSH).

13. The method of claim 1, wherein the plurality of CTBs have variable sizes, and each CTB corresponds to a square block.

14. The method of claim 1, wherein the CTB types allowed for the plurality of CTBs include at least one of 256×256 block, 128×128 block, 64×64 block, 32×32 block, 16×16 block, or 8×8 block.

15. A decoding apparatus configured to decode a bitstream for at least one picture, the picture including at least one slice, the slice including a plurality of coding tree blocks (CTBs), the decoding apparatus comprising:
a memory; and
a processor operatively connected to the memory, wherein the processor is configured to:
obtain type number information and type information for the plurality of CTBs from the bitstream, the type number information indicating a number of CTB types allowed for the plurality of CTBs, and the type information indicating the CTB types allowed for the plurality of CTBs;
obtain type indication information for a current CTB among the plurality of CTBs from the bitstream, the type indication information indicating one CTB type of the allowed CTB types;
determine a size of the current CTB and a minimum size of a coding block within the current CTB based on the CTB type indicated by the type indication information;
determine at least one coding block within the current CTB based on the determined size of the CTB and the determined minimum size of the coding block;
obtain prediction mode information for each of the at least one coding block from the bitstream, the prediction mode information indicating whether a corresponding coding block is coded using an intra prediction or an inter prediction; and
reconstruct a current coding block based on prediction mode information for the current coding block among the at least one coding block.
